(19) United States
(12) Patent Application Publication
(10) Pub. No.: US 2003/0052765 A1
(43) Pub. Date: Mar. 20, 2003

(54) Inductance part and its manufacturing method

(76) Inventors: Toyonori Kanetaka, Toyooka-shi (JP); Toshihiro Yoshizawa, Toyonaka-shi (JP); Hiromasa Yamamoto, Toyonaka-shi (JP)

Correspondence Address: Parkhurst & Wendel, Suite 210, 1421 Prince Street, Alexandria, VA, 22314-2805, US

(21) Appl. No.: 10/168,171

(22) PCT Filed: Oct. 10, 2001
(86) PCT No.: PCT/JP01/09087

(30) Foreign Application Priority Data
Oct. 19, 2000 (JP) 2000-319014
Oct. 30, 2000 (JP) 2000-330232
Oct. 30, 2000 (JP) 2000-330233

(51) Int. Cl. H01F 5/00

(52) U.S. Cl. 336/200

(57) ABSTRACT

An inductance component comprising a column-shaped magnetic material substrate 21, conductor layer 24 covering ends and a peripheral surface of the substrate, coil portion 27 having groove portion 25 and wire conductor portion 26 formed in the conductor layer covering the peripheral surface, electrode portions 28 including the conductor layer covering the ends of the substrate, and magnetic material portion 31 made of sintered magnetic material on the coil portion, wherein the conductor layer has a melting point higher than a sintering temperature of the sintered magnetic material. The manufacturing process comprises; forming a substrate, forming a conductor layer, forming a coil portion, forming electrode portions at ends of the substrate, and forming a magnetic material portion of sintered magnetic material on the coil portion. The present invention provides an inductance component with high inductance, low magnetic flux leakage, and less bad magnetic effects to adjacent components.

### TECHNICAL FIELD

The present invention relates to an inductance component used in electronic equipments, communication equipments and the like, and a method of manufacturing the same.

### BACKGROUND ART

A conventional inductance component is described in the following with reference to the drawings.

FIG. 16 is a sectional view of a conventional inductance component, and FIG. 17 is a perspective view of a substrate of the inductance component.

In FIG. 16 and FIG. 17, a conventional inductance component comprises a column-shaped substrate 11 made of insulating material, a conductor layer 12 covering the substrate 11, a groove portion 13 formed by cutting the conductor layer 12, a coil portion 14 formed by spirally citting the groove portion 13, electrodes 16 disposed at both end of the substrate 11, and a covering portion 15 made of insulating resin covering the coil portion 14.

Also, the substrate 11 has steps 17 between the ends thereof, forming a recess 18, as shown in FIG. 17, and the coil portion 14 is formed on the recess 18.

Further, there is provided a non-covering portion not covered with insulating resin at each end of the substrate 11, and the electrode 16 is electrically connected to the conductor layer 12 at the non-covering portion.

In the above conventional configuration, magnetic flux generated in the substrate 11 due to the coil portion 14 leaks from the electrode 16.

Accordingly, there arises a problem that it is unable to increase the inductance, and leaked magnetic flux causes bad magnetic effects to the adjacent components.

An object of the present invention is to provide an inductance component increased in inductance and minimized in bad magnetic effects given to adjacent components.

### DISCLOSURE OF THE INVENTION

The inductance component of the present invention comprises a column-shaped substrate made of magnetic material, a conductor layer covering the end portion and the peripheral surface of the substrate, a coil portion having a groove portion and wire conductor portion formed in the conductor layer covering the peripheral surface, an electrode portion including a conductor layer covering the end portions of the substrate, and a magnetic material portion made of sintered magnetic material formed on the coil portion, wherein the conductor layer has a melting point higher than the sintering temperature of the sintered magnetic material.

Also, the manufacturing process comprises the steps of forming a substrate made of magnetic material, forming a conductor layer on the end portion and peripheral surface of the substrate, forming a coil portion in the conductor layer on the peripheral surface, forming an electrode portion at the end portions of the substrate, and forming a magnetic material portion made of sintered magnetic material on the coil portion by sintering magnetic material at a temperature lower than the melting point of the conductor layer.

By the above configuration and manufacturing method, a magnetic material made of magnetic material is formed on the coil portion, and therefore, magnetic flux generated in the substrate due to the coil portion goes out of the substrate and passes through the magnetic material portion and again passes through the substrate, and thereby, a closed magnetic circuit loop is formed between the magnetic material portion and the substrate. Accordingly, it is possible to obtain an inductance component increased in inductance, less in magnetic flux leakage, and reduced in bad magnetic effects given to adjacent components.

### BRIEF DESCRIPTION OF TEH DRAWINGS

FIG. 1 is a front sectional view of an inductance component in the first preferred embodiment of the present invention.

FIG. 2 is a plan sectional view of the inductance component.

FIG. 3 is a perspective view of the inductance component.

FIG. 4 is a perspective view of a substrate of the inductance component with a conductor layer covered.

FIGS. 5A and 5B are sectional views showing the flow of magnetic flux generated by the coil portion of the inductance component.

FIG. 6 is a manufacturing process chart of the inductance component.

FIG. 7 is a front sectional view of another inductance component.

FIG. 8 is a front sectional view of an inductance component in the second preferred embodiment of the present invention.

FIG. 9 is a plan sectional view of the inductance component

FIG. 10 is a perspective view of the inductance component.

FIG. 11 is a perspective view of a substrate of the inductance component with a conductor layer covered.

FIGS. 12A and 12B are sectional views showing the flow of magnetic flux generated by the coil portion of the inductance component.

FIG. 13 is a manufacturing process chart of the inductance component.

FIG. 14 is a front sectional view of another inductance component.

FIG. 15 is a plan sectional view of another inductance component.

FIG. 16 is a sectional view of a conventional inductance component.

FIG. 17 is a perspective view of the substrate of the inductance component.

### DESCRIPTION OF PREFERRED EMBODIMENTS

First Preferred Embodiment

The first preferred embodiment will be described in the following with reference to the drawings.

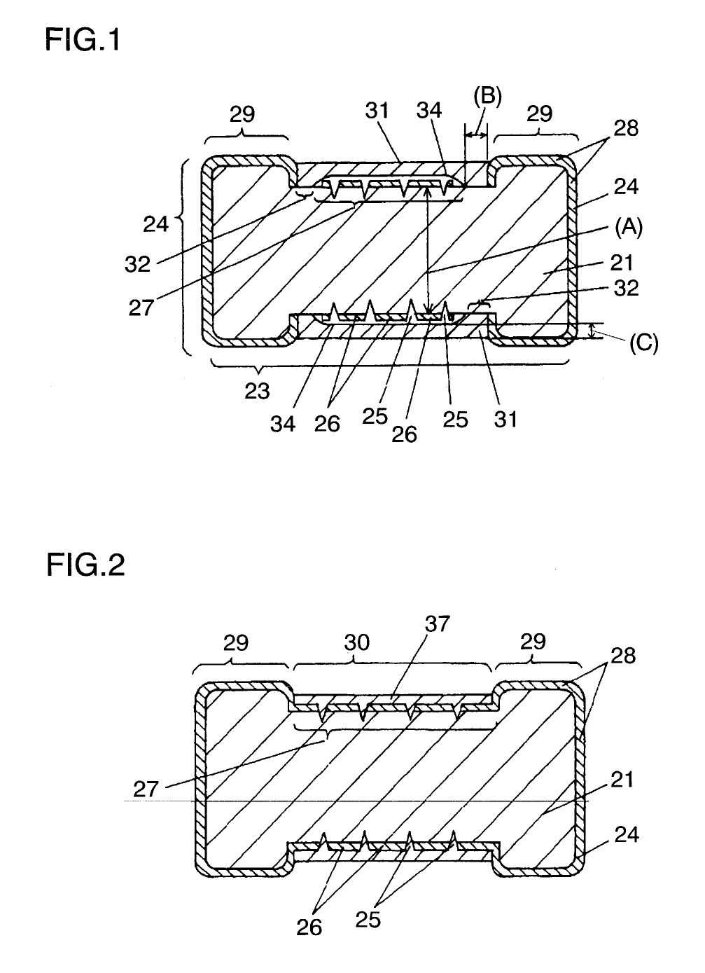

In FIG. 1-FIG. 4, an inductance component in the first preferred embodiment of the present invention comprises a column-shaped substrate 21 made of magnetic material, a conductor layer 24 covering the end surfaces 22 and peripheral surface 23 of the substrate 21, a coil portion 27 having a groove portion 25 and wire conductor portion 26, formed by spirally cutting the conductor layer 24 by a laser beam, and an electrode portion 28 formed of the conductor layer 24 covering both end portions 29 of the substrate 21. The substrate 21 is, as shown in FIG. 2, provided with a recess 30 between the end portions 29, and the coil portion 27 is disposed in the recess 30.

Also, there is provided a magnetic material portion 31 made of a magnetic material on the coil portion 27. The magnetic material portion 31 is a sintered magnetic material formed by sintering magnetic material, and the conductor layer 24 is a conductor having a melting point higher than a sintering temperature of the sintered magnetic material.

In this embodiment, the substrate 21 and magnetic material portion 31 are sintered magnetic material made of sintered ferrite formed by sintering Ni—Zn ferrite material, and conductor layer 24 is a 10 to 30 μm thick conductor formed by an electrolytic plating of Ag or Ag—Pd.

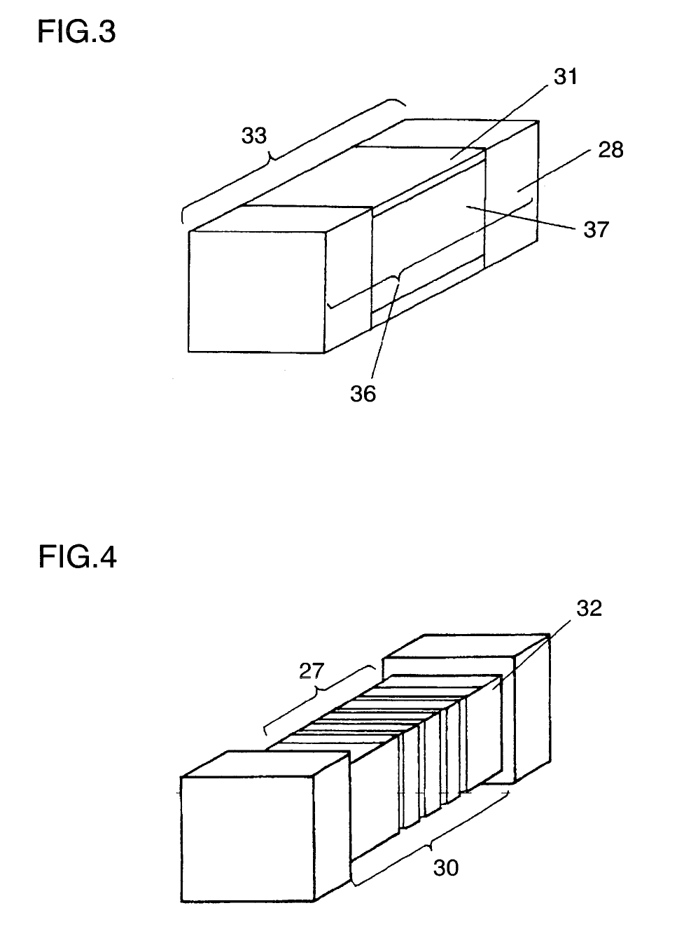

Further, the conductor layer 24 is removed between the coil portion 27 and electrode portions 28, thereby forming a conductor layer removed portion 32 where the substrate 21 is exposed, and in the conductor layer removed portion 32 is also provided with the magnetic material portion 31 in order to establish contact between the substrate 21 and the magnetic material portion 31. Particularly, the conductor layer removed portion 32 is, as shown in FIG. 3, disposed on one of opposing surfaces 33 of the substrate 21, and the magnetic material portion 31 is also disposed on the coil portion 27 on the surface 33, thereby establishing a contact between the substrate 21 and the magnetic material portion 31 so that they are melted and sintered into one body.

In the mean time, a non-magnetic material 34 made of glass, a nonmagnetic material, is disposed in layer between the coil portion 27 of surface 33 and the magnetic material portion 31, and also, the groove portion 25 of the coil portion 27 is filled with the non-magnetic material 34. A covering portion 37 made of glass is layered on the coil portion 27 of the other surface 36 of the substrate 21.

That is, the cross-section of the surface 33 is as shown in FIG. 1, and the cross-section of the surface 36 is as shown in FIG. 2.

In the above configuration, in the conductor layer removed portion 32, the total area of facing-to-substrate area (B) of the magnetic material portion 31 facing to the substrate 21 is larger than a sectional area in a radial direction of the substrate 21 (hereinafter called as a radial sectional area) (A) at the position where the coil portion 27 is formed, and a total area of the sectional area in the radial direction of the substrate 21 of the magnetic material portion 31 disposed on the coil portion 27 (hereinafter called as a peripheral sectional area) (C) is larger than the radial sectional area (A) of the substrate 21 at the position where the coil portion 27 is formed.

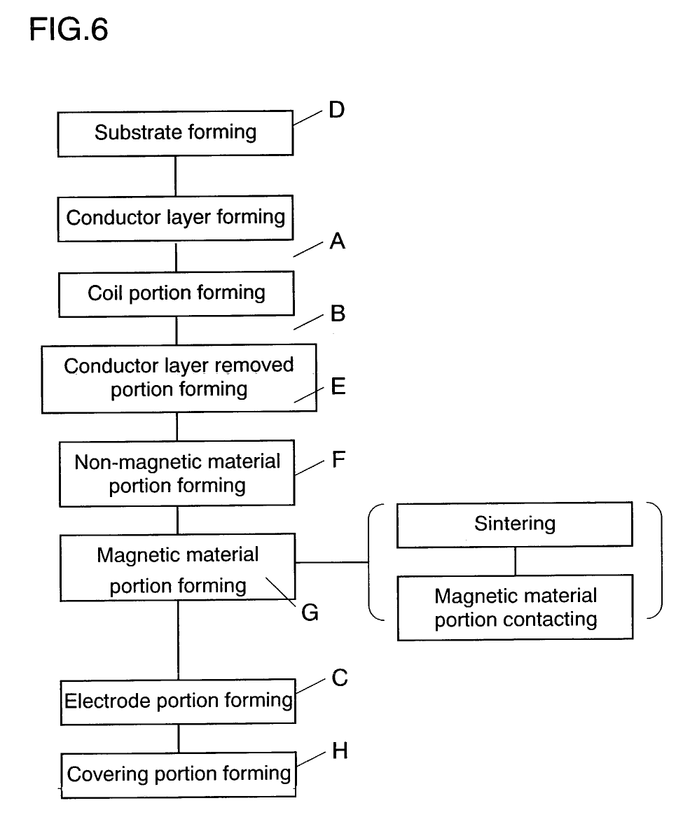

The method of manufacturing an inductance component as described above comprises, as shown in FIG. 6, a conductor layer forming process (A) for forming conductor layer 24 on the substrate by covering the end surface 22 and peripheral surface 23 of the substrate 21, a coil portion forming process (B) for forming coil portion 27 having groove portion 25 and wire conductor portion 26, formed by spirally cutting the conductor layer 24 covering the peripheral surface 23 of the substrate 21, and an electrode portion forming process (C) for forming electrode portion 28 at each end portion 29 of the substrate 21.

Before the conductor layer forming process, there are provided a step of substrate forming process (D) for making a column-shaped substrate 21, and a recess forming process for forming recess 30 where the coil portion 27 is disposed between the end portions 29 of the substrate 21.

Also, after the coil portion forming process, there are provided a conductor layer removed portion forming process (E) for making the substrate 21 exposed by partly removing conductor layer 24 from the surface 33 of the substrate 21, and a non-magnetic material forming process (F) for forming non-magnetic material 34 between the coil portion 27 and magnetic material portion 31. Particularly, in the non-magnetic material forming process (F), non-magnetic material 34 is filled into the groove portion 25 of the coil portion 27 as well.

Further, there is provided a magnetic material forming process (G) for disposing magnetic material portion 31 made of magnetic material in the recess 30 on the coil portion 27 of the surface 33. This magnetic material forming process includes a magnetic material contacting process for establishing contact between the substrate 21 and the magnetic material portion 31, and a sintering process making the magnetic material portion 31 into a sintered magnetic material by sintering magnetic material at a temperature lower than the melting point of the conductor layer 24. Particularly, the magnetic material contacting process is a step of establishing contact between the substrate 21 and the magnetic material portion 31 so that they are melted and sintered into one body in the sintering process.

And, at the final stage of this manufacturing process, there is provided a covering portion forming process (H) for forming covering portion 37 made of glass on the coil portion 27 of the other surface 36 of the substrate 21.

The operation of an inductance component having the above configuration will be described in the following.

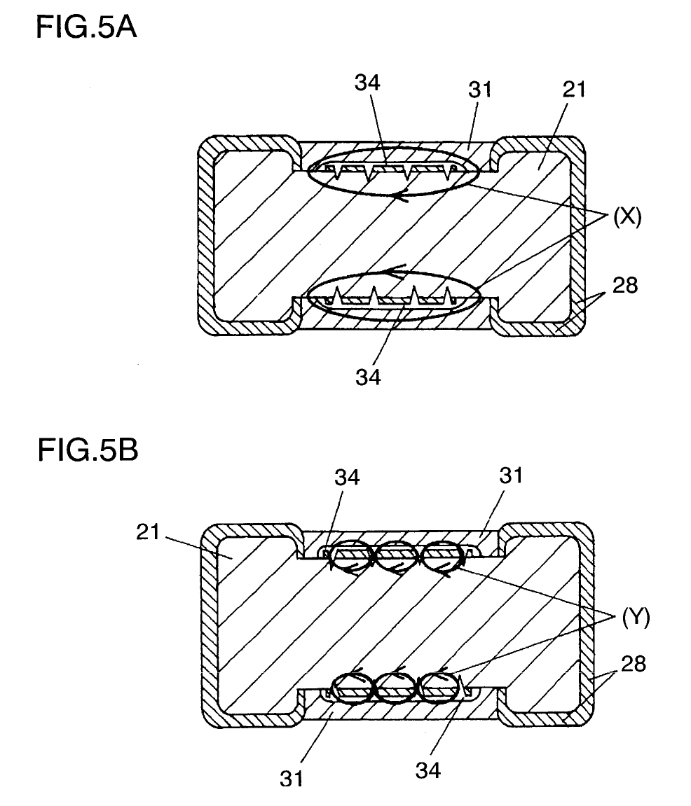

An inductance manufactured by the manufacturing method as described above is provided with magnetic material portion 31 made of magnetic material on coil portion 27. Therefore, as shown in FIG. 5A, magnetic flux (X) generated in substrate 21 due to coil portion 27 goes out of the substrate 21 and passes through the magnetic material portion 31 and again passes through the substrate 21. Consequently, there is practically no magnetic flux (Y) (FIG. 5B) that passes around the wire conductor portion 26 of the coil portion 27, forming a closed magnetic circuit loop between magnetic material portion 31 and substrate 21, and thereby, the inductance may be increased. Further, since magnetic flux (X) is hard to leak out of the inductance component, it is possible to suppress bad magnetic effects given to adjacent components.

Particularly, according to the present preferred embodiment, since magnetic material portion 31 is a sintered magnetic material formed by sintering magnetic material, the magnetic material portion 31 is increased in magnetic permeability, and the inductance of the inductance component may be increased, and also, bad magnetic effects given to adjacent components can be further suppressed.

Also, since the conductor layer 24 is a conductor having a melting point higher than the sintering temperature of the sintered magnetic material, even when magnetic material is disposed and sintered on the coil portion 27, it causes no melting of the conductor layer 24 at the sintering temperature and it is possible to prevent generation of short circuitting or connection trouble caused due to melting of the conductor layer 24, and there is no deterioration of the conduction reliability of the conductor layer 24.

In the present preferred embodiment, making a paste by mixing the magnetic material with an organic solvent, binder or the like and applying the obtained paste on the coil portion 27, make it possible to dispose a magnetic material even in case of an inductance component having a complicated shape, and to form more precisely a closed magnetic circuit loop between magnetic material portion 31 and substrate 21, and to increase the inductance.

Also, since there is provided a recess 30 between the end portions 29 of the substrate 21, the magnetic material portion 31 is surrounded by the end portions 29, making the magnetic flux (X) easier to pass from the substrate 21 to the magnetic material portion 31, then increasing in magnetic permeability, and the inductance may be further increased. Particularly, the magnetic material portion 31 is disposed in the recess 30, and therefore, the magnetic material portion 31 does not protrude from the end portions 29 of the substrate 21, and the flatness of the inductance component can be improved.

In addition, in the present preferred embodiment, a conductor layer removed portion 32 is provided between coil portion 27 and electrode portion 28, and magnetic material portion 31 is disposed in the conductor layer removed portion 32, thereby establishing contact between substrate 21 and magnetic material portion 31. Accordingly, when magnetic flux (X) generated at the coil portion 27 passes from the substrate 21 to the magnetic material portion 31, the magnetic flux (X) passes via the conductor removed portion 32, and then the flow of the magnetic flux (X) is hardly blocked by the conductor layer 24. As a result, it is possible to realize efficient fow of the magnetic flux (X), increasing the magnetic permeability, and to further increase the inductance of the inductance component.

Particularly, since the substrate 21 and magnetic material portion 31 are melted and sintered into one body, there exists practically no interface between the substrate 21 and magnetic material portion 31, it is possible to make smooth flow of magnetic flux (X) and to further increase the inductance.

Also, since the substrate 21 is column-shaped and the conductor layer removed portion 32 is disposed on two surfaces 33 opposing to each other, and also, the magnetic material portion 31 is disposed on the coil portion 27 of surface 33, most of the magnetic flux (X) may pass from the substrate 21 to the magnetic material portion 31 via the conductor layer removed portion 32 provided on the surface 33. Also, it is possible to realize efficient flow of the magnetic flux (X) because the magnetic flux (X) folws symmetrically, resulting in enhancing the magnetic permeability, and the inductance may be increased.

Particularly, on the other two surfaces 36 opposing to each other is only formed protective glass as a covering portion 37, therefore the magnetic flux (X) does not folw through the glass on the coil portion 27. Further, when an inductance component is mounted on a circuit board, effects from the circuit patterns or soldered connections of the circuit board can be minimized by mounting the inductance component in such manner that the surfaces 33 with magnetic material portion 31 disposed thereon are positioned rectangular to the circuit board.

In addition, there is provided non-magnetic material 34 between coil portion 27 and magnetic material portion 31, and the groove portion 25 of the coil portion 27 is also filled with the non-magnetic material 34. Therefore, the groove portion 25 of coil portion 27 and the adjacent area of wire conductor portion 26 are coated with non-magnetic material 34, and a closed magnetic circuit loop due to a flow of magnetic flux (X) is not formed between neighboring wire conductor portions 26 of the coil portion 27. As a result, most of the magnetic flux (X) generated due to the coil portion 27 passes from the substrate 21 to the magnetic material portion 31 and from the magnetic material portion 31 to the substrate 21, thus forming a closed magnetic circuit loop and enhancing the magnetic permeability, and the inductance may be further increased.

Particularly, it is possible to further enhance the above effect since nonmagnetic material 34 is layered between coil portion 27 and magnetic material portion 31, and at the same time, the non-magnetic material 34 is made of glass. In case the non-magnetic material 34 is not provided, a corrosion of the coil portion 27 may occur because the magnetic material portion 31 is a sintered magnetic material formed by sintering magnetic material including a number of small pores or the like, and through the pores moisture in the air is absorbed into the magnetic material portion 31 to corrode the coil portion 27. However, in the present preferred embodiment, a layer of glass is disposed between the coil portion 27 and magnetic material portion 31, it is possible to suppress absorption of water in the air and to prevent sticking of water to the coil portion 27.

Further, the total area of facing-to-substrate area (B) of the magnetic material portion 31 facing to the substrate in the conductor layer removed portion 32 is larger than the radial sectional area (A) of the substrate 21 at the position where the coil portion 27 is formed, and the total area of the peripheral sectional area (C) of the coil portion of the magnetic material portion 31 disposed on the coil portion 27 is larger than the radial sectional area (A) of the substrate 21 at the position where the coil portion 27 is formed. As a result, magnetic flux (X) generated at the coil portion 27 is not saturated and efficiently passes from the substrate 21 to the magnetic material portion 31, thereby enhancing the magnetic permeability, and thus the inductance may be increased.

Moreover, the substrate 21 and magnetic material portion 31 are sintered magnetic material made of sintered ferrite formed by sintering Ni—Zn ferrite material, and the conductor layer 24 is a conductor made of Ag or Ag—Pd. Accordingly, when magnetic material is sintered at the sintering temperature, bad effects caused by a heat for the sintering are hardly given to the conductor layer 24, thereby improving the conduction reliability of the conductor layer 24.

In this way, according to the first preferred embodiment of the present invention, as shown in FIG. 5A, magnetic flux (X) generated in the substrate 21 due to coil portion 27 goes out from the substrate 21 and passes through the magnetic material portion 31 and again passes through the substrate 21, thereby forming a closed magnetic circuit loop between the magnetic material portion 31 and the substrate 21, and thus the inductance can be increased, and also the magnetic flux (X) is hard to leak and it is possible to suppress bad magnetic effects given to adjacent components.

Also, short circuitting or connection trouble caused due to melting of the conductor layer 24 and corrosion of coil portion 27 caused by water absorbed in the sintered magnetic material can be prevented, and also it is possible to suppress the deterioration of the conduction reliability of the conductor layer 24.

Further, the magnetic flux (X) does not pass through the other opposing surfaces 36, and in mounting on a circuit board, effects from the circuit patterns or soldered connections of the circuit board can be minimized by mounting the inductance component in such manner that opposing surfaces 33 (where magnetic material portion 31 is disposed) are positioned perpendicular to the mounted board.

In the first preferred embodiment of the present invention, the non-magnetic material 34 is layered between the coil portion 27 and magnetic material portion 31 is made of glass, but it is also possible to obtain similar effects by using air or ceramic as the non-magnetic material 34.

Also, covering portion 37 made of glass is disposed on the coil portion 27 of the other opposing surface 36 of the substrate 21, but it is also possible to obtain similar effects by using insulating resin as covering portion 37.

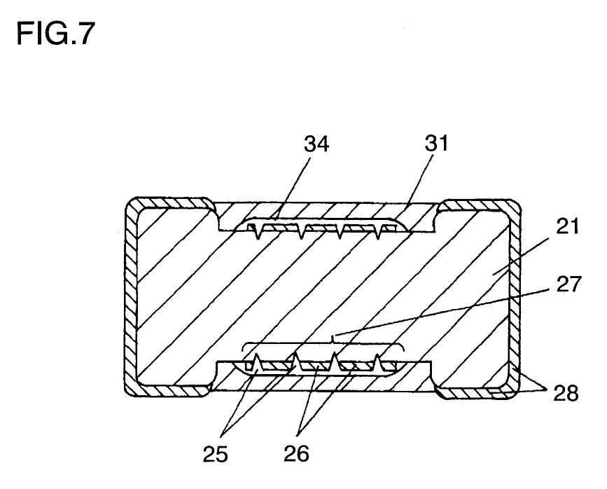

Further, the contact between each end portion 29 of the substrate 21 and the magnetic material portion 31 is established via conductor layer 24, but it is also possible to establish direct contact between each end portion 29 of the substrate 21 and the magnetic material portion 31 as shown in FIG. 7.

Second Preferred Embodiment

The second preferred embodiment will be described in the following with reference to the drawings.

The inductance component in the second preferred embodiment of the present invention is an improved version of the inductance component in the first preferred embodiment of the present invention.

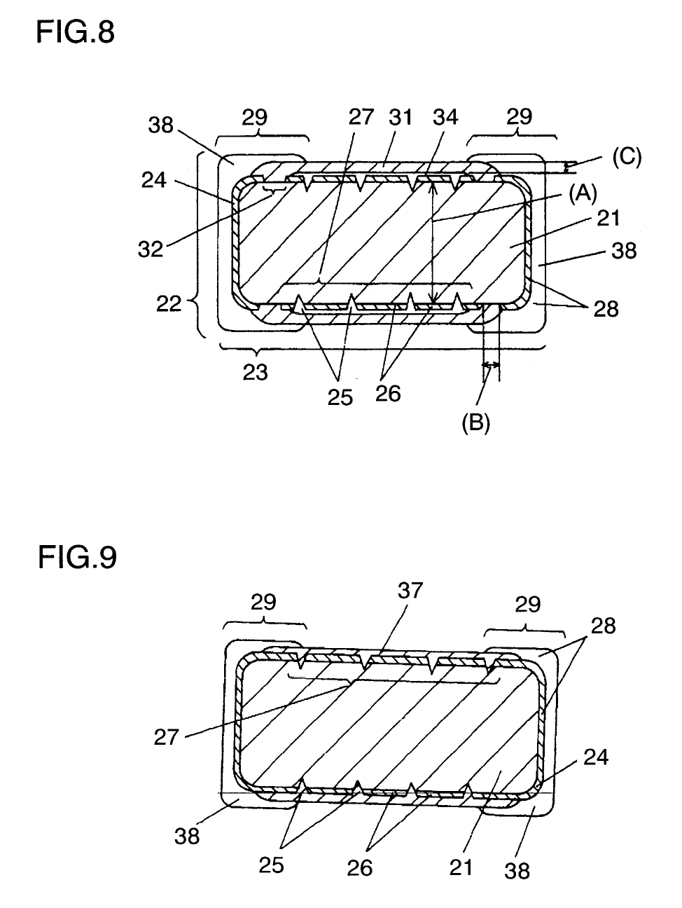

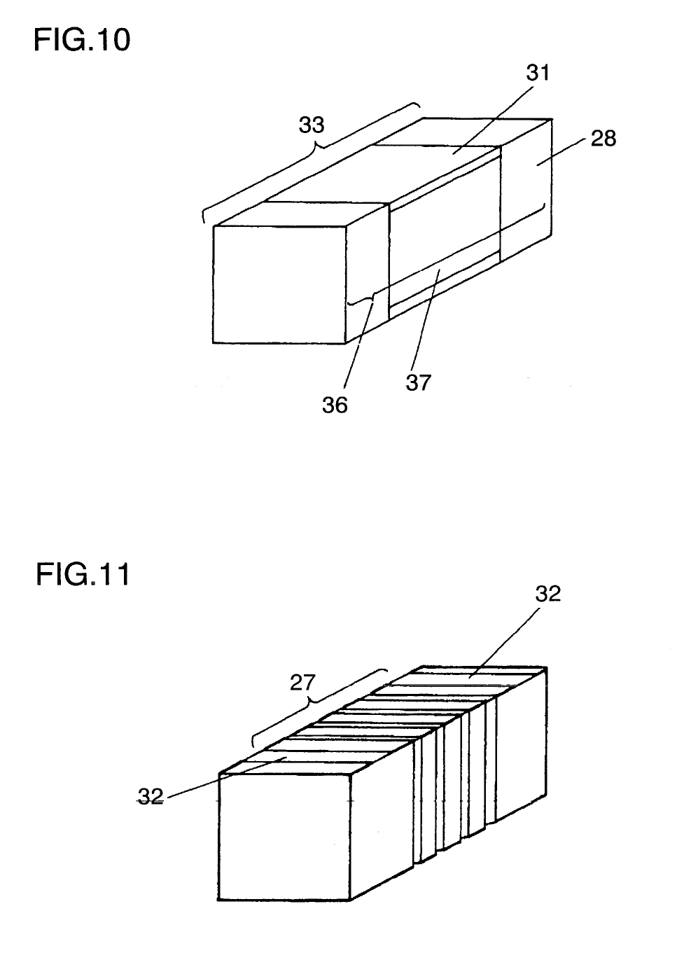

In FIG. 8 to FIG. 11, the inductance component in the second preferred embodiment of the present invention comprises a parallelpiped column shaped substrate 21 made of magnetic material, a conductor layer 24 covering the end surface 22 and peripheral surface 23 of the substrate 21, a coil portion 27 having groove portion 25 and wire conductor portion 26, formed by spirally cutting the conductor layer 24 covering the peripheral surface 23 of the substrate 21, and an electrode portion 28 of the conductor layer 24 covering each end portion 29 of the substrate 21.

Also, on the coil portion 27 is disposed a magnetic material portion 31 made of magnetic material, and the magnetic material portion 31 is a sintered magnetic material formed by sintering magnetic material, and the conductor layer 24 is a conductor having a melting point higher than the sintering temperature of the sintered magnetic material.

Further, an electrode layer 38 formed of conductor opposes to each end portion of the coil portion 27 via each end portion of magnetic material portion 31 disposed on the coil portion 27, and the electrode layer 38 is a part of electrode portion 28.

That is, the inductance component of the present preferred embodiment includes no recess in the middle of substrate 21 in the configuration of the first preferred embodiment, and the electrode layer 38 opposing to each end portion of coil portion 27 is added in the configuration via each end portion of magnetic material portion 31.

The substrate 21 and magnetic material portion 31, the material, configuration and forming method of the conductor layer 24 are identical with those in the first preferred embodiment.

The present preferred embodiment is same as the first preferred embodiment with respect to the contacting and sintering method for the magnetic material portion 31 and conductor layer removed portion 32, exposing the substrate 21 by removing the conductor layer 24 between the coil portion 27 and electrode portion 28. The present preferred embodiment is also same as the first preferred embodiment with respect to the material, configuration and forming method for non-magnetic material 34 and covering portion 37 which are both made of glass.

At each end portion of covering portion 37 is disposed the electrode layer 38 so opposing to each end portion of the coil portion 27.

Also, in the conductor layer removed portion 32 disposed between the coil portion 27 and the electrode portion 28 at one end portion, the total area of facing-to-substrate area (B) of the magnetic material portion 31 facing to the substrate 21 is larger than the radial sectional area (A) of the substrate 21 at the position where the coil portion 27 is formed, and the total area of the peripheral sectional area (C) of the coil portion of the magnetic material portion 31 disposed on the coil portion 27 is larger than the radial area (A) of the substrate 21 at the position where the coil portion 27 is formed.

Regarding the method of manufacturing the above inductance component, the difference from the manufacturing process in the first preferred embodiment shown in FIG. 6 will be described in the following.

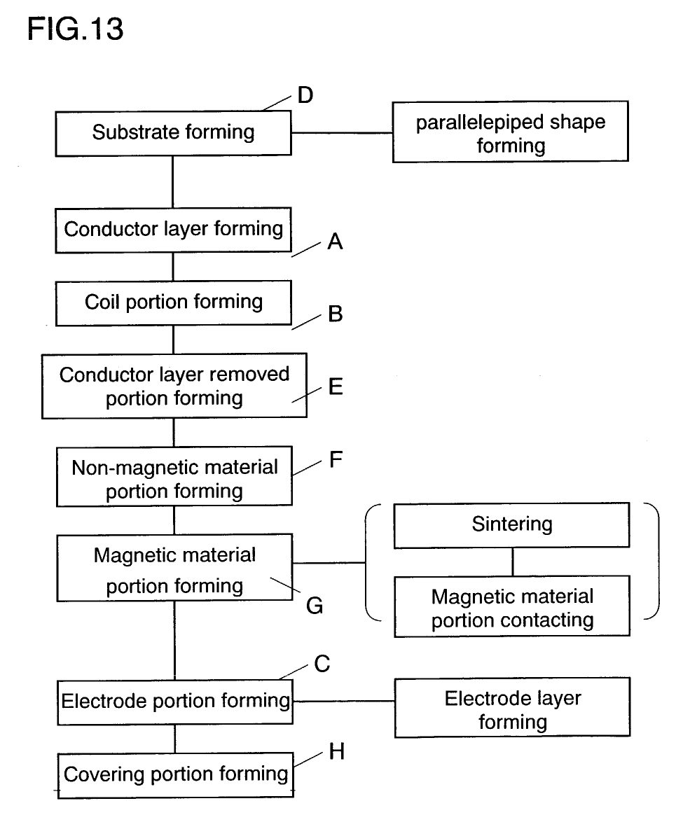

In the present preferred embodiment, as shown in FIG. 13, recess 30 is not formed in the substrate 21 during the substrate forming process (D), but there is provided a parallelpiped shape forming process for forming the substrate 21 into parallelpiped shape. In the coil portion forming process (B) coil portion 27 is formed from one peripheral end of the substrate 21 to another peripheral end thereof. The electrode portion forming process (C) includes an electrode layer forming process for forming electrode layer 38 made of conductor on the magnetic material portion 31 disposed on the coil portion 27 so as to oppose to the coil portion 27, and the electrode layer 38 is a part of the electrode portion 28.

The operation of an inductance component having the above configuration is described in the following.

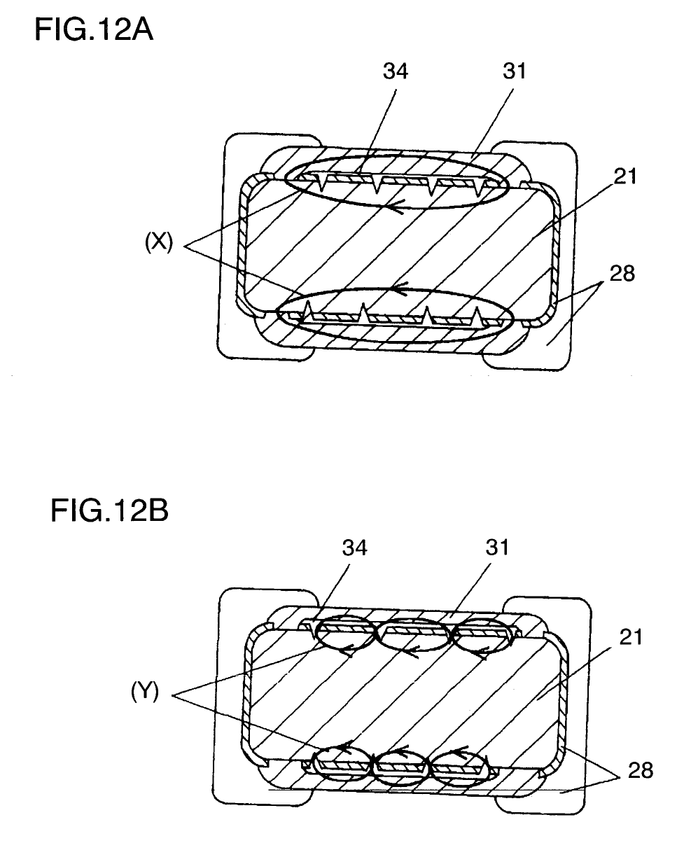

An inductance component manufactured by the above manufacturing method is provided with magnetic material portion 31 made of magnetic material on the coil portion 27, and as shown in FIG. 12A, magnetic flux (X) generated in the substrate 21 by the coil portion 27 goes out of the substrate 21 and passes through the magnetic material portion 31 and again passes through the substrate 21. As a result, there is practically no magnetic flux (Y) that passes around the wire conductor portion 26 of the coil portion 27 as shown in FIG. 12B, thereby forming a closed magnetic circuit loop between the magnetic material portion 31 and the substrate 21. Accordingly, the inductance of the inductance component may be increased and the magnetic flux (X) is hard to leak, making it possible to suppress bad magnetic effects given to adjacent components.

Particularly, since the magnetic material portion 31 is a sintered magnetic material formed by sintering magnetic material, the magnetic permeability is enhanced and the inductance may be further increased, and it is possible to more suppress bad magnetic effects given to adjacent components.

Also, the conductor layer 24 is a conductor having a melting point higher than the sintering temperature of the sintered magnetic material, and therefore, even in case magnetic material is disposed and sintered on the coil portion 27, it will not cause melting of the conductor layer 24 at the sintering temperature and is possible to prevent generation of short circuitting or connection trouble due to melting of the conductor layer 24, and there will be no deterioration of the conduction reliability of the conductor layer 24.

In the present preferred embodiment, making a paste by mixing the magnetic material with a binder or the like and applying it on the coil portion 27, make it possible to dispose magnetic material even in the case of an inductance component having a complicated shape and to precisely form a closed magnetic circuit loop between the magnetic material portion 31 and the substrate 21, and thus the inductance may be increased.

Further, the electrode layer 38 is arranged on the magnetic material portion 31 disposed on the coil portion 27, and the electrode layer 38 is a part of the electrode portion 28, therefore the electrode portion 28 can be formed on the peripheral end of the substrate 21. Accordingly, when the inductance component is mounted, the continuity to the circuit patterns on the circuit board is improved. And the coil portion 27 can be formed almost up to the ends of the substrate 21, the inductance can be increased. Particularly, since the coil portion 27 is formed from one peripheral end of the substrate 21 to another peripheral end thereof, it is possible to increase the inductance.

And, between the coil portion 27 and the electrode portion 28 is disposed a conductor removed portion 32 where the substrate 21 is exposed by removing the conductor layer 24, and there is provided magnetic material portion 31 in the conductor removed portion 32, thereby establishing contact between the substrate 21 and the magnetic material portion 31. Accordingly, when magnetic flux (X) generated at the coil portion 27 passes from the substrate 21 to the magnetic material portion 31, the magnetic flux (X) passes via the conductor removed portion 32, and the flow of magnetic flux (X) is not blocked by the conductor layer 24. As a result, the magnetic flux (X) can be efficiently passed, enhancing the magnetic permeability, and thus the inductance may be further increased.

Particularly, since the substrate 21 and the magnetic material portion 31 are melted and sintered into one body, there is practically no interface between the substrate 21 and the magnetic material portion 31, making easier the flow of magnetic flux (X), and the inductance may be further increased.

Also, the conductor layer removed portion 32 is disposed on two surfaces 33 of the substrate 21 opposing to each other, and also the magnetic material portion 31 is disposed on the coil portion 27 of the pair of surfaces 33 where the conductor layer removed portion 32 is formed. Accordingly, most of the magnetic flux (X) passes from the substrate 21 to the magnetic material portion 31 via the conductor layer removed portion 32, and at the same time, the magnetic flux (X) can be passed symmetrically. In this way, the magnetic flux (X) is efficiently passed, enhancing the magnetic permeability, and the inductance may be increased.

Particularly, on the other two surfaces 36 opposing to each other have only protective glass as a covering portion 37, therefore the magnetic flux (X) does not pass through the glass on the coil portion 27. Also, when an inductance component is mounted on a circuit board, effects from the circuit patterns or soldered connections of the mounted board can be minimized by mounting the inductance component in such manner that the pair of surfaces 33 with magnetic material portion 31 disposed thereon are positioned perpendicular to the mounted board.

In addition, there is provided non-magnetic material 34 between coil portion 27 and magnetic material portion 31, and the groove portion 25 of the coil portion 27 is also filled with the non-magnetic material 34. Therefore, the groove portion 25 of coil portion 27 and the adjacent area of wire conductor portion 26 are coated with non-magnetic material 34, and a closed magnetic circuit loop caused due to passage of magnetic flux (X) is not formed between the coil portion 27 and wire conductor portion 26. As a result, most of the magnetic flux (X) generated by the coil portion 27 passes from the substrate 21 to the magnetic material portion 31 and from the magnetic material portion 31 to the substrate 21, forming a closed magnetic circuit loop, resulting in enhancing the magnetic permeability, and thus the inductance may be further increased.

Particularly, it is possible to further enhance the above effect because nonmagnetic material 34 is layered between the coil portion 27 and magnetic material portion 31, and also, the non-magnetic material 34 is made of glass.

In case the non-magnetic material 34 is not provided, there is a problem of corrosion of the coil portion 27 because the magnetic material portion 31 is a sintered magnetic material formed by sintering magnetic material having a number of snall pores or the like through which moisture contained in the air is absorbed into the magnetic material portion 31. However, in the present preferred embodiment, since a layer of glass is formed between the coil portion 27 and magnetic material portion 31, it is possible to suppress absorption of moisture in the air and to prevent sticking of water to the coil portion 27.

Also, the total area of facing-to-substrate area (B) of the magnetic material portion 31 facing to the substrate 21 in the conductor layer removed portion 32 is larger than the radial sectional area (A) of the substrate 21 at the position where the coil portion 27 is formed, and the total area of the peripheral sectional area (C) of the coil portion of the magnetic material portion 31 disposed on the coil portion 27 is larger than the radial sectional area (A) of the substrate 21 at the position where the coil portion 27 is formed. Accordingly, magnetic flux (X) generated at the coil portion 27 is not saturated and efficiently passes from the substrate 21 to the magnetic material portion 31. As a result, the magnetic permeability is enhanced, and the inductance may be increased.

In addition, the substrate 21 and magnetic material portion 31 are sintered magnetic material made of sintered ferrite formed by sintering Ni—Zn ferrite material, and the conductor layer 24 is a conductor made of Ag or Ag—Pd. Accordingly, when magnetic material is sintered at the sintering temperature, bad effects caused by a heat for the sintering are hardly given to the conductor layer 24, thereby improving the conduction reliability of the conductor layer 24.

Thus, according to the present preferred embodiment, as shown in FIG. 12A, magnetic flux (X) generated in the substrate 21 by coil portion 27 goes out of the substrate 21 and passes through the magnetic material portion 31 and again passes through the substrate 21. Then, a closed magnetic circuit loop is formed between the magnetic material portion 31 and the substrate 21, and thus the inductance may be increased, and also the magnetic flux (X) is hard to leak and it is possible to suppress bad magnetic effects to adjacent components.

Also, short circuitting or connection trouble caused due to melting of the conductor layer 24 and corrosion of coil portion 27 caused by water absorbed in the sintered magnetic material can be prevented, and also it is possible to suppress the deterioration of the conduction reliability of the conductor layer 24.

Further, the magnetic flux (X) does not pass through the other opposing surfaces 36, and in mounting on the curcuit board, effects from the circuit patterns or soldered connections of the mounted board can be minimized by mounting the inductance component in such manner that the two opposing surfaces 33 (where magnetic material portion 31 is disposed) are parallel to the circuit board.

In one preferred embodiment of the present invention, the non-magnetic material 34 layered between the coil portion 27 and magnetic material portion 31 is a glass layer, but it is also possible to obtain similar effects by using a ceramic layer. Further, it is possible to provide an air layer as the non-magnetic material 34. Such air layer can be formed, for example, by disposing a thermosetting resin layer at a place of the non-magnetic material 34, and burn out the thermosetting resin layer during firing of the magnetic material portion 31.

Also, covering portion 37 disposed on the coil portion 27 of the other opposing surfaces 36 of the substrate 21 is made of glass, but it is also possible to obtain similar effects by using insulating resin.

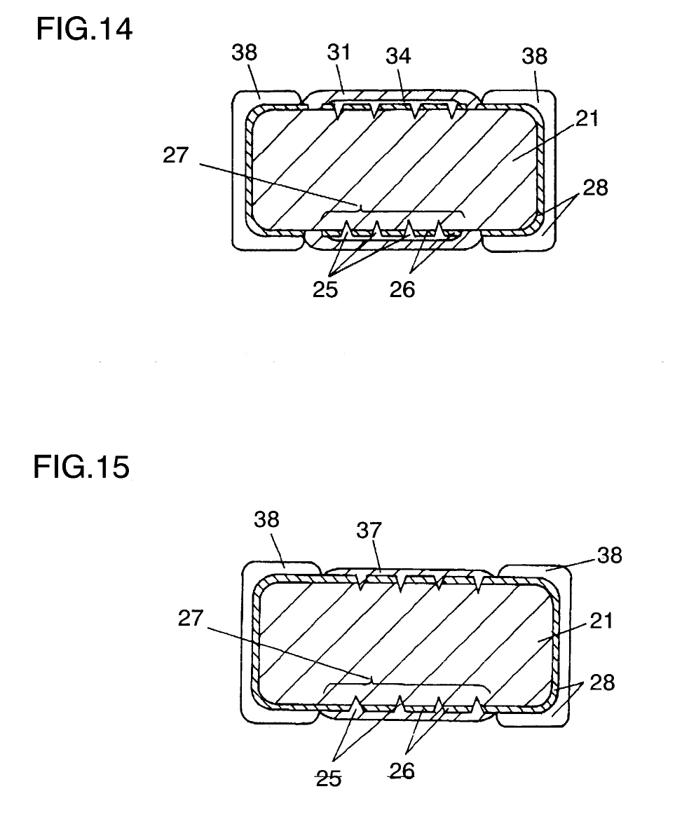

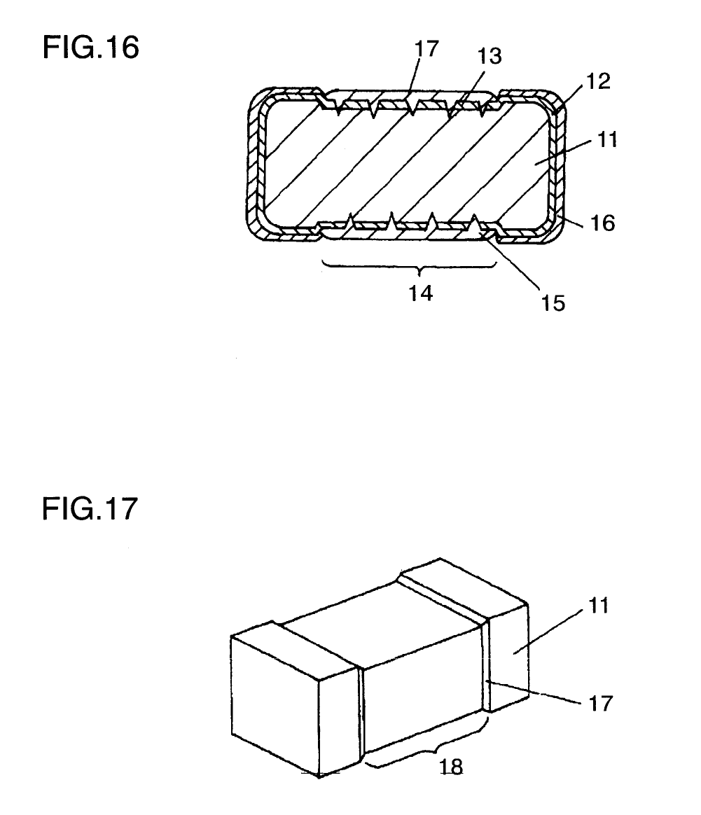

Further, the electrode portion 28 disposed at each end portion 29 of the substrate 21 is provided with electrode layer 38 formed on magnetic material portion 31 so as to oppose to the end of the coil portion 27. However, as shown in FIG. 14 and FIG. 15, it is also possible to form the electrode layer 38, not on the magnetic material portion 31 and covering portion 37 and so as not to oppose to the coil portion 27.

In the above preferred embodiment, as a cutting method, a laser method is described, but the cutting method is not limited to the laser method. It is a matter of course that mechanical cutting, chemical etching, and other well-known cutting methods may be employed.

### INDUSTRIAL APPLICABILITY

As described above, according to the present invention, magnetic flux generated in the substrate by the coil portion goes out of the substrate and passes through the magnetic material portion and again passes through the substrate, thereby forming a closed magnetic circuit loop between the magnetic material portion and the substrate. Accordingly, it is possible to provide an inductance component increased in inductance, less in magnetic flux leakage, and reduced in bad magnetic effects to adjacent components.

1. An inductance component comprising:
a column-shaped substrate made of magnetic material;
a conductor layer covering end portions and peripheral surface of said substrate;
a coil portion having a groove portion and a wire conductor portion formed in said conductor layer covering said peripheral surface;
an electrode portion formed of said conductor layer covering end portions of said substrate; and
a magnetic material portion made of a sintered magnetic material formed on said coil portion,
wherein said conductor layer has a melting point higher than a sintering temperature of said sintered magnetic material.

2. The inductance component of claim 1, wherein a recess in which said coil portion is formed is provided between the end portions of said substrate.

3. The inductance component of claim 1, wherein a recess in which said coil portion is formed is provided between the end portions of said substrate, and said magnetic material portion is disposed in said recess.

4. The inductance component of claim 1, wherein a conductor layer removed portion is provided between said coil portion and said electrode portion.

5. The inductance component of claim 1, wherein said substrate and said magnetic material are made of sintered ferrite.

6. The inductance component of claim 1, wherein said substrate and said magnetic material are sintered Ni—Zn ferrite, and said conductor layer is one of Ag and Ag—Pd alloy.

7. The inductance component of claim 1, wherein a conductor removed portion is provided between said coil portion and said electrode portion, and the magnetic material portion is also formed in said conductor layer removed portion to make a contact between said substrate and said magnetic material portion.

8. The inductance component of claim 7, wherein in said electrode layer removed portion provided between said coil portion and one of said electrode portions, an area of said magnetic material facing to said substrate is larger than a sectional area of said substrate in a radial direction of said substrate at a position where said coil portion is formed.

9. The inductance component of claim 7, wherein a sectional area of said magnetic material portion on said coil portion in the radial direction of said substrate is larger than the sectional area of the substrate in the radial direction of said substrate at the position where said coil portion is formed.

10. The inductance component of claim 7, wherein said substrate and said magnetic material portion are sintered into one body.

11. The inductance component of claim 7, wherein said substrate has a parallelpiped shape, and said conductor layer removed portion is provided on each of a pair of opposing surfaces of said substrate, and said magnetic material portion is disposed on a coil portion formed on each of said pair of opposing surfaces of said substrate.

12. The inductance component of claim 11, wherein a covering portion made of insulating resin is disposed on a coil portion on one of another opposing surfaces of said substrate.

13. The inductance component of claim 11, wherein a covering portion made of glass is disposed on a coil portion on one of another opposing surfaces of said substrate.

14. The inductance component of claim 11, wherein an electrode layer opposes to each end portion of said coil portion via each end portion of said magnetic material portion formed on said coil portion, said electrode layer being a part of said electrode portion.

15. The inductance component of claim 11, wherein said coil portion is formed from one peripheral end of said substrate to another peripheral end thereof.

16. The inductance component of claim 1, further comprising a non-magnetic material portion provided between said coil portion and said magnetic material.

17. The inductance component of claim 16, wherein the groove portion of said coil portion is also filled with said non-magnetic material portion.

18. The inductance component of claim 16, wherein said non-magnetic material portion is one of a glass layer, ceramic layer and air layer formed between said coil portion and said magnetic material portion.

19. A method of manufacturing an inductance component comprising the steps of:
forming a substrate made of magnetic material;
forming a conductive layer on a side surface and on a peripheral surface of said substrate;
forming a coil portion comprising a groove portion and a wire conductor portion on said conductor layer on said peripheral surface;
forming an electrode portion at each end portion of said substrate; and
forming a magnetic material portion made of sintered magnetic material on said coil portion by sintering magnetic material at a temperature lower than a melting point of said conductor layer.

20. The method of manufacturing an inductance component of claim 20, further comprising the steps of:
forming a recess between the end portions of said substrate in said substrate forming process; and
forming a magnetic material portion in the recess in said magnetic material portion forming step.

21. The method of manufacturing an inductance component of claim 19, further comprising the steps of:
forming a conductor layer removed portion for forming a conductor layer removed portion where the substrate is exposed by removing the conductor layer between the coil portion and the electrode portion; and
contacting a magnetic material portion to said substrate for establishing contact between said substrate and said magnetic material portion by forming a magnetic material portion in said conductor layer removed portion in said magnetic material forming process.

22. The method of manufacturing an inductance component of claim 21, wherein said magnetic material portion contacting step further includes a step of melting and sintering said substrate and said magnetic material into one body.

23. The method of manufacturing an inductance component of claim 21, further comprising the steps of:
forming a column shaped substrate in said substrate forming step;
forming a conductor removed portion on a pair of opposing surfaces of said substrate in said conductor layer removed portion forming step; and
forming a magnetic material portion on a coil portion of said pair of opposing surfaces in said magnetic material portion forming step.

24. The method of manufacturing an inductance component of claim 23, further comprising a step of forming a covering portion made of insulating resin on a coil portion formed on another opposing surfaces of said substrate.

25. The method of manufacturing an inductance component of claim 23, further comprising a step of forming a covering portion made of glass on a coil portion formed on another opposing surfaces of said substrate.

26. The method of manufacturing an inductance component of claim 19, further comprising a step of forming a non-magnetic material portion between said coil portion and said magnetic material portion after said coil portion forming step.

27. The method of manufacturing an inductance component of claim 26, wherein the non-magnetic material is also filled into the groove portion of said coil portion in said non-magnetic material forming step.

28. The method of manufacturing an inductance component of claim 19, further comprising the steps of:
foring said substrate into parallelpiped shape in said substrate forming step; and
forming an electrode layer made of a conductor on said magnetic material portion formed on said coil portion in said electrode portion forming step, said electrode layer opposing to said coil portion and said electrode layer being a part of said electrode portion.
